(19) United States
(12) Patent Application Publication
(10) Pub. No.: US 2014/0162584 A1
(43) Pub. Date: Jun. 12, 2014

(54) SAFETY GUN HOLSTER

(71) Applicant: Sammy Cope, Gilbert, AZ (US)

(72) Inventor: Sammy Cope, Gilbert, AZ (US)

(21) Appl. No.: 13/709,043

(22) Filed: Dec. 9, 2012

(51) Int. Cl. F41C 33/02; H04W 4/22

(52) U.S. Cl. CPC F41C 33/029; H04W 4/22
USPC 455/404.1; 224/243

(57) ABSTRACT

Systems, methods and apparatus are provided through which in some implementations a wired switch or sensor with a mounting system is mounted on a holster and is interfaced either electrically or through a radio transmitter to the radio in order to trip a panic button.

### FIELD

The field of the invention is gun holsters and more specifically safety devices for gun holsters.

### BRIEF DESCRIPTION

In one aspect, an apparatus includes a gun holster, a sensor mounted on the gun holster that is operable to detect a weapon draw and a link operably coupled to the sensor that is operable to trigger a panic button condition to a radio of an officer in response to detection of the weapon draw by the sensor, the link being a component of the apparatus.

In a further aspect, an apparatus includes a sensor operable to be mounted and that is operable to detect a weapon draw and an transmitter that is operably coupled to the sensor, the transmitter being operable to communicate a message in response to detection of the weapon draw by the sensor.

In another aspect, a method includes detecting a weapon draw and communicating a message, in response to detection of the weapon draw.

Gun safety apparatus of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a top-view isometric diagram of a safety gun holster apparatus, according to an implementation;

FIG. 2 is a side-view cross section block diagram of the safety gun holster apparatus, according to the same implementation;

FIG. 3 is a top-view isometric diagram of a safety gun holster apparatus, according to an implementation;

FIG. 4 is a block diagram triggering apparatus of a panic button condition of a safety gun holster apparatus, according to an implementation;

FIG. 5 is a flowchart of a method of a safety gun holster apparatus, according to an implementation;

FIG. 6 is a flowchart of a method of communicating a message, according to an implementation;

FIG. 7 is a block diagram of a transmitter, according to an implementation; and

FIG. 8 is a block diagram of a radio, according to an implementation.

### DETAILED DESCRIPTION

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into four sections. In the first section, apparatus described. In the second section, a method is described. In the third section, a description of electrical components is provided. In the fourth section, a conclusion of the detailed description is provided.

### Apparatus

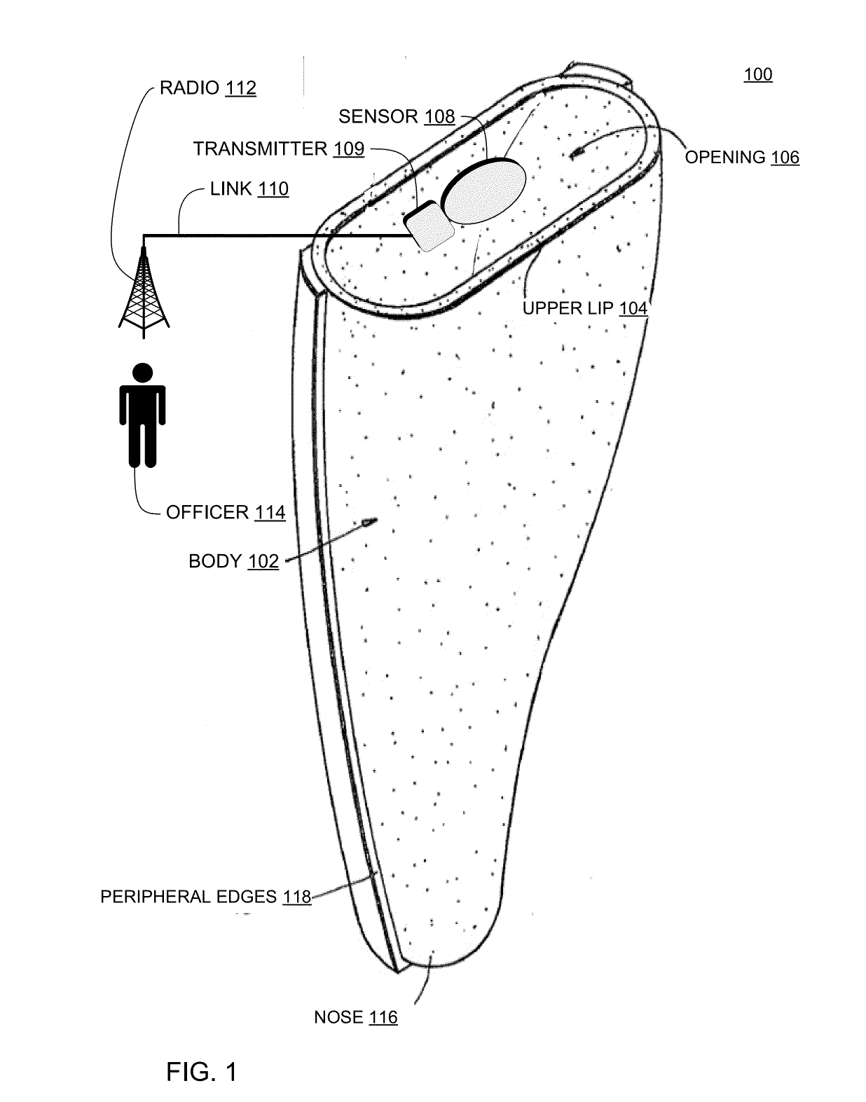

FIG. 1 is a top-view isometric diagram of a safety gun holster apparatus 100, according to an implementation. Apparatus 100 includes a body 102. The body 102 includes an upper lip 104 defining an opening 106 which is large enough to receive a body of a handgun (not shown).

Apparatus 100 also includes a sensor 108 mounted on, or in, the gun holster that is operable to detect a draw of a weapon from the body 102. Apparatus 100 also includes a transmitter 109 that is operably coupled to the sensor 108. The transmitter 109 is operable to communicate a message over a link 110 in response to detection of the weapon draw by the sensor.

The link 110 is operably coupled to the sensor 108 through the transmitter 109. The link 110 is operable to send the message, or other triggered panic button condition, to a radio 112 of an officer 114 in response to detection of the weapon draw by the sensor 108. In the embodiment shown in FIG. 1, the link 110 is a component of the apparatus 100. In other embodiments, the link 110 is a wireless communication path. Detection of the weapon draw by the sensor can trigger notification, alarm or distress call of the weapon draw to a dispatch office and/or a signal to switch a radio of the officer into a hands-free mode. Switching the radio of the officer into a hands-free mode is intended to provide hand-free operation of the radio which is very important when the officer has drawn their weapon from the gun holster 100. Apparatus 100 also includes a component that is coupled to at least one of the sensor 108 and the transmitter 109, operable to prevent false alarms when the officer is off-duty. An alternative to the dispatch office, the notification can be sent to a response center, a dispatcher, an operator, a call monitor, a call monitor, an emergency responder, emergency responders, a sheriff office, deputy, patrol or law enforcement.

The opposite end of the body 102 from the opening 106 tapers to a rounded nose 116 which generally conforms to the barrel of the handgun. Preferably, the body 102 of the apparatus 100 is constructed from leather, thereby taking advantage of the appearance, feel, and flexibility provided by that substance. Apparatus 100 also includes peripheral edges 118.

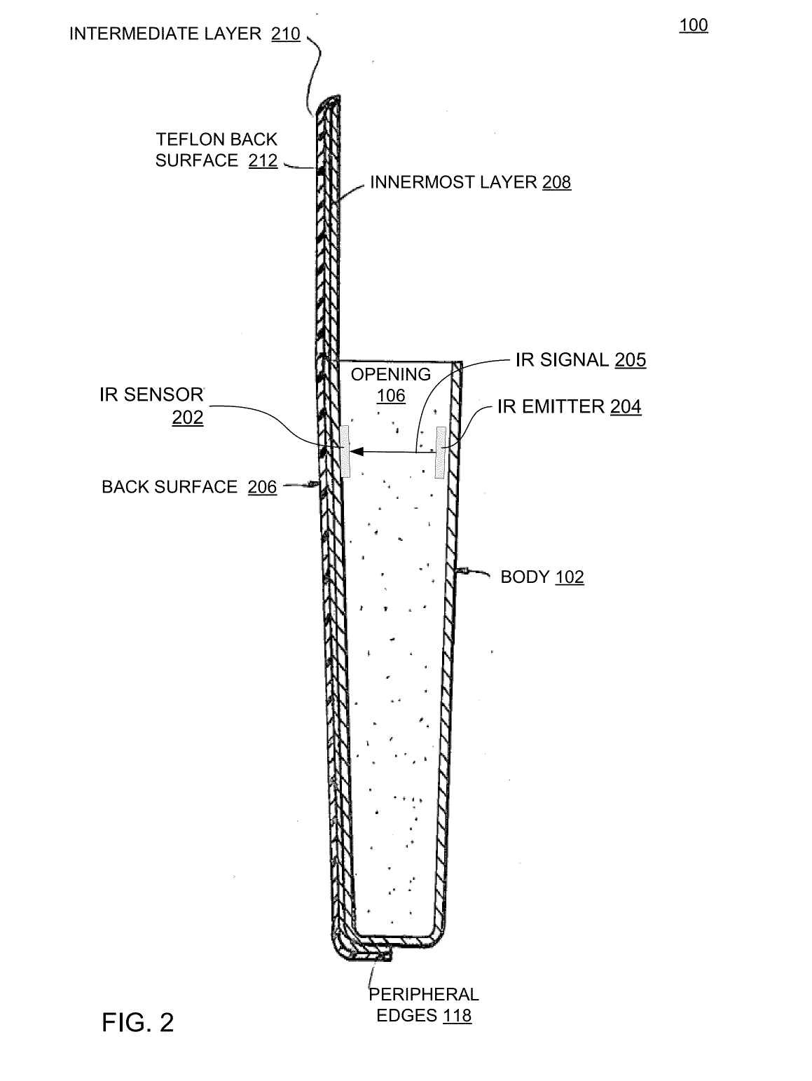

FIG. 2 is a side-view cross section block diagram of the safety gun holster apparatus 100, according to the same implementation.

In the implementation shown in FIG. 2, the sensor 108 is an infrared (IR) sensor 202. The IR sensor 202 is positioned in the apparatus 100 across from an IR emitter 204. When a gun or other object is placed in the opening 106 of the apparatus, an IR signal 205 from the IR emitter 205 is interrupted and the interrupted signal is interpreted as a gun being in the holster. When a gun or other object is withdrawn from the opening 106 of the apparatus, the IR signal 205 from the IR emitter 204 is uninterrupted and the uninterrupted signal is interpreted as a gun being drawn from the holster. The positions of the IR sensor 202 and the IR emitter 204 can be reversed in relation to each other so that the IR sensor 202 is mounted where the IR emitter 204 is shown in FIG. 2 and the IR emitter 204 is mounted where the IR sensor 202 is shown in FIG. 2.

In the implementation shown in FIG. 2, a back face or surface 206 of the apparatus 100 is formed of a laminate of three different layers. An innermost layer 208 includes a flap which is an extension of the leather body 102 forming the holster 100 and defines a tab to fasten the holster. The intermediate layer 210 is a cloth like material that allows any moisture to preferably migrate thereto as by wicking action to serve as a hydrophilic layer relative to the leather to preserve the leather. The intermediate layer 210 and a Teflon™ coated back surface 212 extend around the body 102 of the apparatus 100 defining a folded marginal edge portion in order that the peripheral edges 118, FIG. 1, do not provide pressure areas or snags for the user. Other implementations of apparatus 100 having or not having the back face or surface 206, the innermost layer 208 and the intermediate layer 210 are within contemplation.

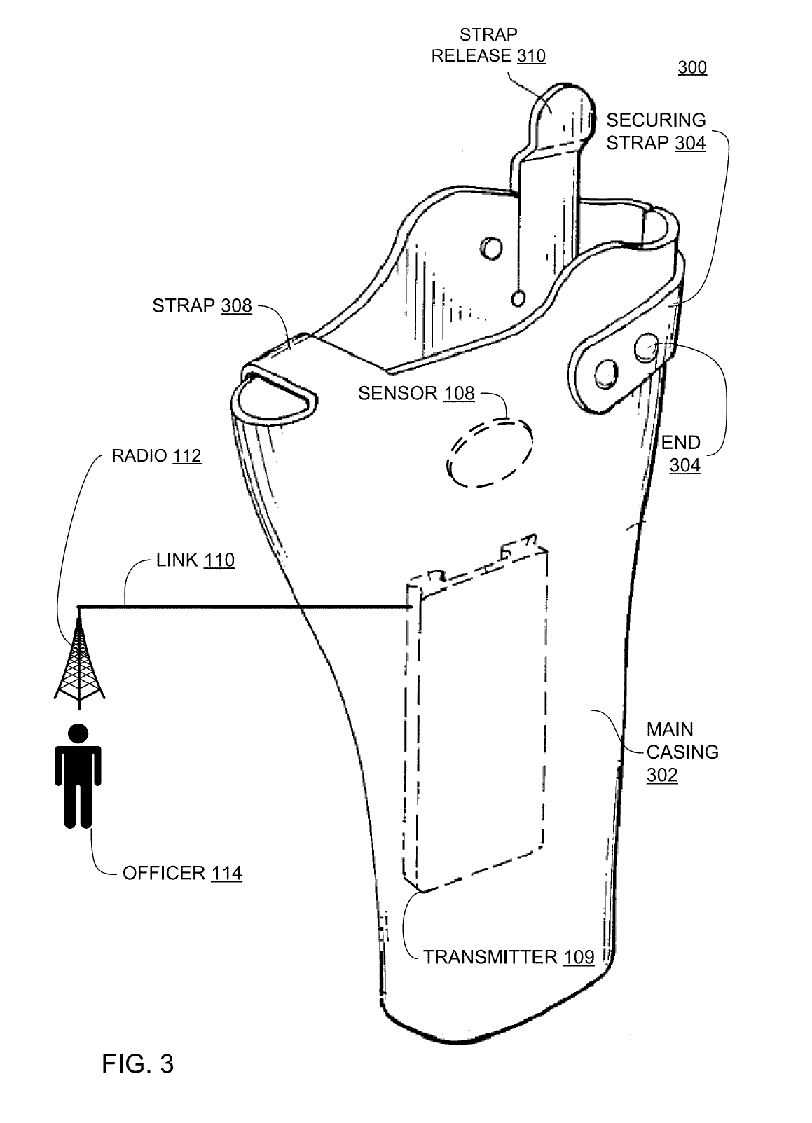

FIG. 3 is a top-view isometric diagram of a safety gun holster apparatus 300, according to an implementation.

Apparatus 300 includes a sensor 108 mounted on, or in, the gun holster that is operable to detect a draw of a weapon from the body 102. Apparatus 300 also includes a transmitter 109 that is operably coupled to the sensor 108. The transmitter 109 is operable to communicate a message over a link 110 in response to detection of the weapon draw by the sensor.

The link 110 is operably coupled to the sensor 108 through the transmitter 109. The link 110 is operable to send the message, or other triggered panic button condition, to a radio 112 of an officer 114 in response to detection of the weapon draw by the sensor 108. In the embodiment shown in FIG. 1, the link 110 is a component of the apparatus 300. In other embodiments, the link 110 is a wireless communication path. Detection of the weapon draw by the sensor can trigger notification to dispatch of the weapon draw and/or a signal to switch a radio of the officer into a hands-free mode. Switching the radio of the officer into a hands-free mode is intended to provide hand-free operation of the radio which is very important when the officer has drawn their weapon from the gun holster 300.

Apparatus 300 includes a main casing 302 in which a gun can be carried. A securing strap 304 having a permanently mounted end 306 to the outside of the casing to the inside of the holster as seen in FIG. 3 of the drawings. Strap 304 when in a secured position prevents the front end of the holster from being opened. Provided towards the back and extending across the top of the casing is a second strap 308. Strap 308 is formed by an extension of the holster which is then bent down and secured to the other side of the holster. The only way that the gun can be withdrawn from the holster is by first releasing strap 304 by means of a strap release 310. Release strap 310 is an integral part of the casing 302 and comprises a plastic piece upstanding from the remainder of the casing as shown in FIG. 3. Any one of the straps 304, 308 or strap release 310 can be operable to act as a switch/wired circuit break so that when the straps 304, 308 or strap release 310 holding the gun in place is removed, a circuit is broken (or completed) and signals that the gun has been removed.

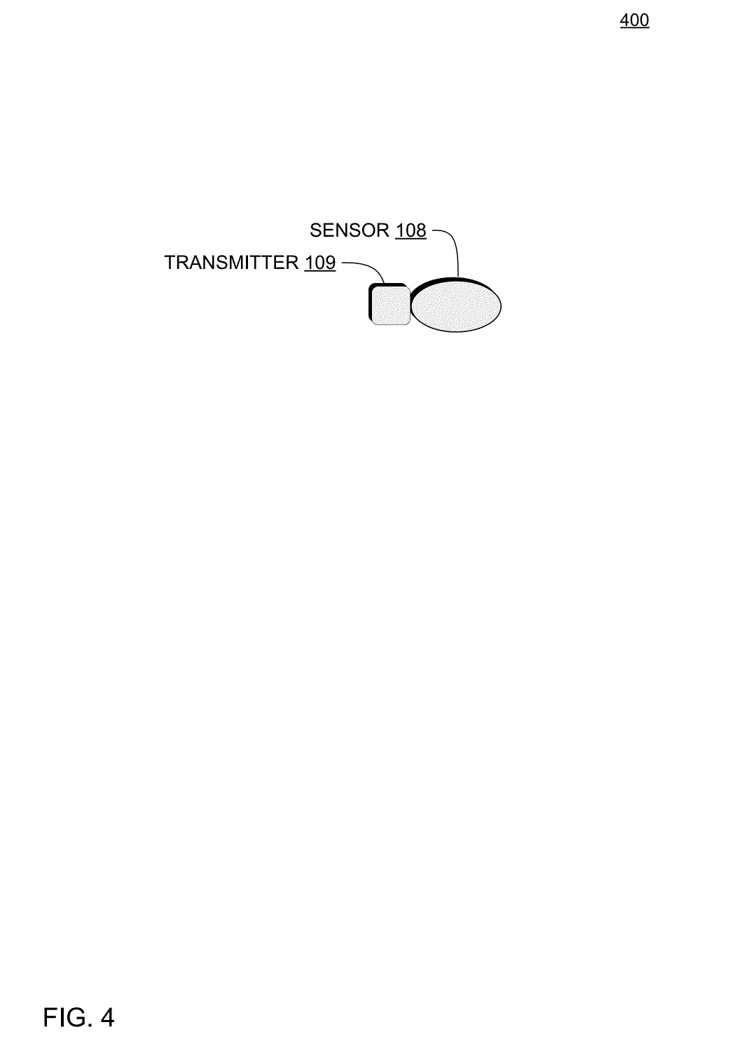

FIG. 4 is a block diagram triggering apparatus 400 of a panic button condition of a safety gun holster apparatus, according to an implementation. Apparatus 400 also includes a sensor 108 that is operable to be mounted on, or in, the gun holster. The sensor 108 is operable to detect a draw of a weapon from the vicinity of the sensor. Apparatus 400 also includes a transmitter 109 that is operably coupled to the sensor 108. The transmitter 109 is operable to communicate a panic message over a link (such as link 110) in response to detection of the weapon draw by the sensor. In some implementations, the triggering apparatus 400 includes an attachment device that is operable to mechanically couple the triggering apparatus 400 to another device, such as a holster. The attachment device can include a spring-loaded clip.

### Method

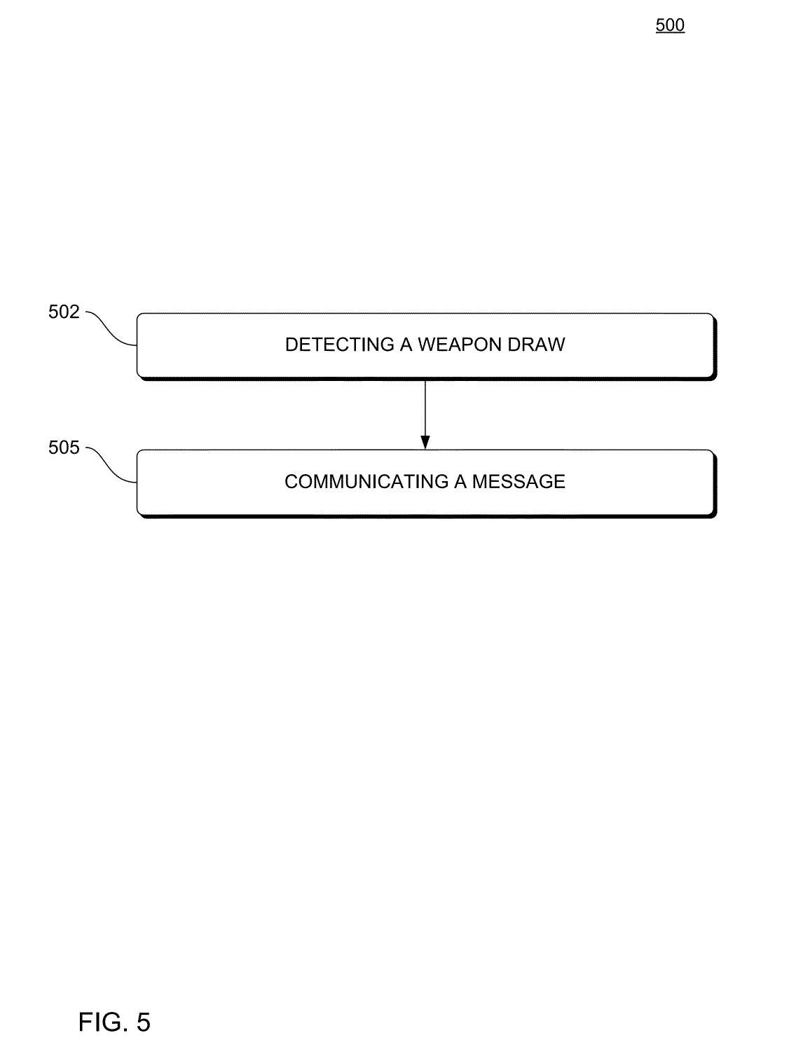

FIG. 5 is a flowchart of a method 500 of a safety gun holster apparatus, according to an implementation. Method 500 includes detecting a weapon draw, at block 502 and communicating a message, in response to detection of the weapon draw, at block 504. One example of communicating a message is method 600 below.

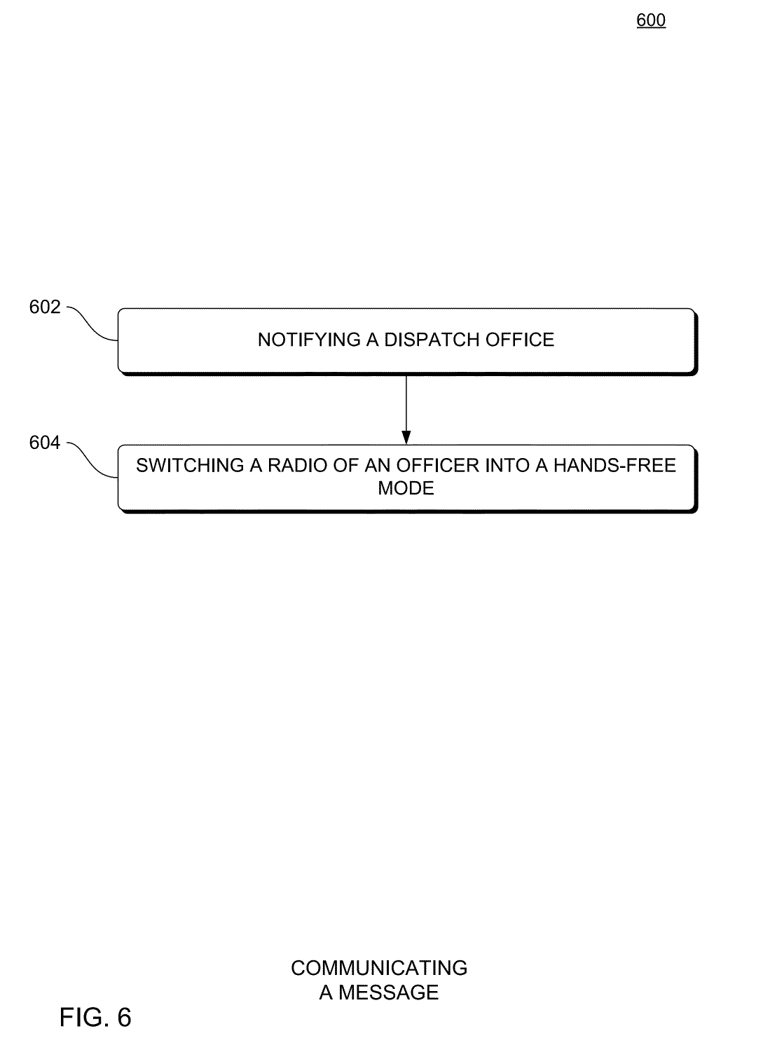

FIG. 6 is a flowchart of a method 600 of communicating a message, according to an implementation. Method 600 is one example of communicating a message at step 504 in FIG. 5. Method 600 includes notifying a dispatch office, at block 602 and switching a radio of an officer into a hands-free mode, at block 604.

### Electrical Components

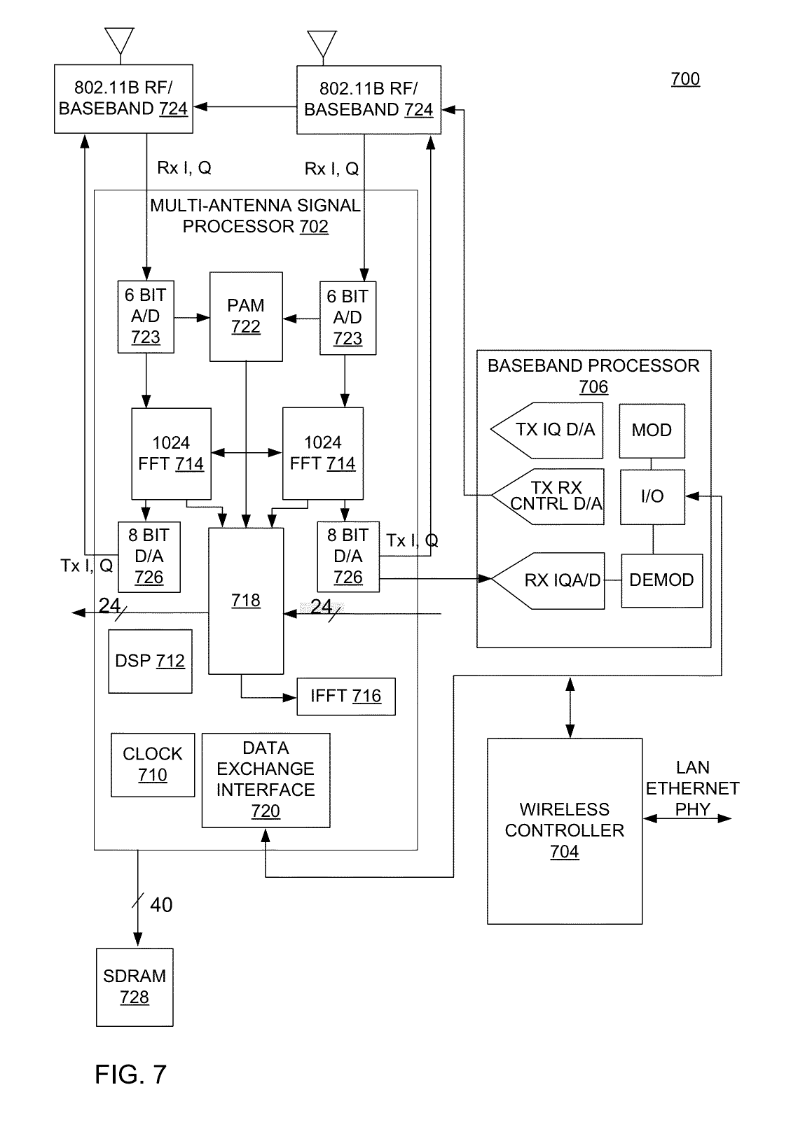

FIG. 7 is a block diagram of a transmitter 700, according to an implementation. The transmitter 700 is one example of the transmitter 109 in FIG. 1 and FIG. 3. The transmitter 700 includes a multi-antenna signal processor 702, a wireless media access controller 704 and a baseband processor 706, which can be incorporated as part of a single chip integrated circuit. In some implementations, can include a clock generator 710 which generates a set of clocks for all internal modules from a 44 MHz master clock, a SDRAM buffer interface address generator in a DSP 712 a 22 mhz three 1024-point FFT switchable circuit 714 operable to transform received signal samples of multiple RF to the frequency domain using FFT, a 22 mhz three 1024-point IFFT switchable circuit 716 operable to reconstruct a received signal in the time domain, a separation matrix multiplier 718 operable to separate signals, an on chip parameter memory bank, an inter-chip data exchange interface 720 which controls software access to internal registers as well as reading/writing of signaling messages, a digital signal processor interface, a preamble acquisition module (sync—circuit) 722 operable to acquire timing of the received signal samples relative to a local PN code in a PLCP preamble, synchronize the signal samples to FFT frame, and use the known FFT of a preamble to estimate RF channels, four 6-bit 22 MHz A/D 723 performs A/D conversion for I and Q baseband signals received from RF/Baseband front end circuits 724, and four 8 bit 44 MHz D/A 726 operable to convert the recovered signal to an analog form and sending it out to a standard 802.11b DSSS receiver for decoding.

The general purpose DSP 756, which, in combination with SDRAM 728 and D/A blocks 726 and other elements of ASIC 702 performs the following basic operations: Framing of the information bit stream to be transmitted; symbol mapping/encoding of the bits in a transmit frame, scrambling the transmitted data to be transmitted, modulating transmission symbols with Baker or CCK codes necessary for spreading the spectrum of the transmitted data and pre-equalizing the generated waveforms in a frequency domain.

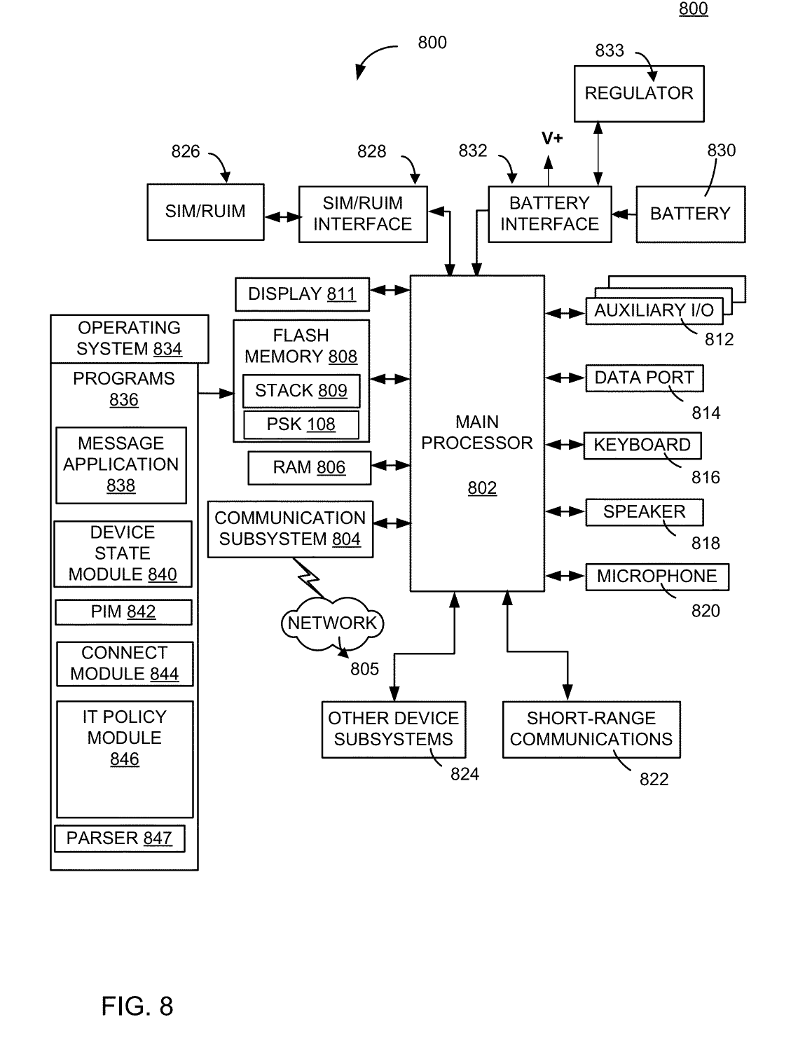

FIG. 8 is a block diagram of a radio 800, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

Radio 800 is one implementation of radio 112 in FIGS. 1 and 3. The radio 800 includes a number of components such as a main processor 802 that controls the overall operation of the radio 800. Communication functions, including data and voice communications, are performed through a communication subsystem 804. The communication subsystem 804 receives messages from and sends messages to wireless networks 805. The wireless networks 805 include the link 110 in FIGS. 1 and 3. In other implementations of the radio 800, the communication subsystem 804 can be configured in accordance with the Global System for Mobile Communication (GSM), General Packet Radio Services (GPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 804 with the wireless network 805 represents one or more different Radio Frequency (RF) channels. With newer network protocols, these channels are capable of supporting both circuit switched voice communications and packet switched data communications.

The main processor 802 also interacts with additional subsystems such as a Random Access Memory (RAM) 806, a flash memory 808, a display 810, an auxiliary input/output (I/O) subsystem 812, a data port 814, a keyboard 816, a speaker 818, a microphone 820, short-range communications 822 and other device subsystems 824. The stack 809 supports authentication and authorization between the radio 800 into a shared Wi-Fi network and both a 3G and 4G mobile networks. The PSK 108 is received by the communication subsystem 804 and transferred by the main processor 802 to the flash memory 808. The PSK 108 is also transferred by the main processor 802 from the flash memory 808 through the short-range communications subsystem 822 to the Wi-Fi access point 104.

Some of the subsystems of the radio 800 perform communication-related functions, whereas other subsystems may provide “resident” or on-device functions. By way of example, the display 810 and the keyboard 816 may be used for both communication-related functions, such as entering a text message for transmission over the wireless network 805, and device-resident functions such as a calculator or task list.

The radio 800 can transmit and receive communication signals over the wireless network 805 after required network registration or activation procedures have been completed. Network access is associated with a subscriber or user of the radio 800. To identify a subscriber, the radio 800 requires a SIM/RUIM card 826 (i.e. Subscriber Identity Module or a Removable User Identity Module) to be inserted into a SIM/RUIM interface 828 in order to communicate with a network. The SIM card or RUIM 826 is one type of a conventional “smart card” that can be used to identify a subscriber of the radio 800 and to personalize the radio 800, among other things. Without the SIM card 826, the radio 800 is not fully operational for communication with the wireless network 805. By inserting the SIM card/RUIM 826 into the SIM/RUIM interface 828, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 826 includes a processor and memory for storing information. Once the SIM card/RUIM 826 is inserted into the SIM/RUIM interface 828, it is coupled to the main processor 802. In order to identify the subscriber, the SIM card/RUIM 826 can include some user parameters such as an International Mobile Subscriber Identity (IMSI). An advantage of using the SIM card/RUIM 826 is that a subscriber is not necessarily bound by any single physical mobile device. The SIM card/RUIM 826 may store additional subscriber information for a mobile device as well, including datebook (or calendar) information and recent call information. Alternatively, user identification information can also be programmed into the flash memory 808.

The radio 800 is a battery-powered device and includes a battery interface 832 for receiving one or more rechargeable batteries 830. In one or more implementations, the battery 830 can be a smart battery with an embedded microprocessor. The battery interface 832 is coupled to a regulator 833, which assists the battery 830 in providing power V+ to the radio 800. Although current technology makes use of a battery, future technologies such as micro fuel cells may provide the power to the radio 800.

The radio 800 also includes an operating system 834 and software components 836 to 846 which are described in more detail below. The operating system 834 and the software components 836 to 846 that are executed by the main processor 802 are typically stored in a persistent store such as the flash memory 808, which may alternatively be a read-only memory (ROM) or similar storage element (not shown). Those skilled in the art will appreciate that portions of the operating system 834 and the software components 836 to 846, such as specific device applications, or parts thereof, may be temporarily loaded into a volatile store such as the RAM 806. Other software components can also be included.

The subset of software applications 836 that control basic device operations, including data and voice communication applications, will normally be installed on the radio 800 during its manufacture. Other software applications include a message application 838 that can be any suitable software program that allows a user of the radio 800 to transmit and receive electronic messages. Various alternatives exist for the message application 838 as is well known to those skilled in the art. Messages that have been sent or received by the user are typically stored in the flash memory 808 of the radio 800 or some other suitable storage element in the radio 800. In one or more implementations, some of the sent and received messages may be stored remotely from the device 800 such as in a data store of an associated host system with which the radio 800 communicates.

The software applications can further include a device state module 840, a Personal Information Manager (PIM) 842, and other suitable modules (not shown). The device state module 840 provides persistence, i.e. the device state module 840 ensures that important device data is stored in persistent memory, such as the flash memory 808, so that the data is not lost when the radio 800 is turned off or loses power.

The PIM 842 includes functionality for organizing and managing data items of interest to the user, such as, but not limited to, e-mail, contacts, calendar events, voice mails, appointments, and task items. A PIM application has the ability to transmit and receive data items via the wireless network 805. PIM data items may be seamlessly integrated, synchronized, and updated via the wireless network 805 with the mobile device subscriber's corresponding data items stored and/or associated with a host computer system. This functionality creates a mirrored host computer on the radio 800 with respect to such items. This can be particularly advantageous when the host computer system is the mobile device subscriber's office computer system.

The radio 800 also includes a connect module 844, and an IT policy module 846. The connect module 844 implements the communication protocols that are required for the radio 800 to communicate with the wireless infrastructure and any host system, such as an enterprise system, with which the radio 800 is authorized to interface. Examples of a wireless infrastructure and an enterprise system are given in FIGS. 21 and 22, which are described in more detail below.

The connect module 844 includes a set of APIs that can be integrated with the radio 800 to allow the radio 800 to use any number of services associated with the enterprise system. The connect module 844 allows the radio 800 to establish an end-to-end secure, authenticated communication pipe with the host system. A subset of applications for which access is provided by the connect module 844 can be used to pass IT policy commands from the host system to the radio 800. This can be done in a wireless or wired manner. These instructions can then be passed to the IT policy module 846 to modify the configuration of the device 800. Alternatively, in some cases, the IT policy update can also be done over a wired connection.

The IT policy module 846 receives IT policy data that encodes the IT policy. The IT policy module 846 then ensures that the IT policy data is authenticated by the radio 800. The IT policy data can then be stored in the flash memory 806 in its native form. After the IT policy data is stored, a global notification can be sent by the IT policy module 846 to all of the applications residing on the radio 800. Applications for which the IT policy may be applicable then respond by reading the IT policy data to look for IT policy rules that are applicable.

The IT policy module 846 can include a parser 847, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 846 can determine which applications are affected by the IT policy data and transmit a notification to only those applications. In either of these cases, for applications that are not being executed by the main processor 802 at the time of the notification, the applications can call the parser or the IT policy module 846 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 846 sends an acknowledgement back to the host system to indicate that the IT policy data was received and successfully applied.

Other types of software applications can also be installed on the radio 800. These software applications can be third party applications, which are added after the manufacture of the radio 800. Examples of third party applications include games, calculators, utilities, etc.

The additional applications can be loaded onto the radio 800 through at least one of the wireless network 805, the auxiliary I/O subsystem 812, the data port 814, the short-range communications subsystem 822, or any other suitable device subsystem 824. This flexibility in application installation increases the functionality of the radio 800 and may provide enhanced on-device functions, communication-related functions, or both. For example, secure communication applications may enable electronic commerce functions and other such financial transactions to be performed using the radio 800.

The data port 814 enables a subscriber to set preferences through an external device or software application and extends the capabilities of the radio 800 by providing for information or software downloads to the radio 800 other than through a wireless communication network. The alternate download path may, for example, be used to load an encryption key onto the radio 800 through a direct and thus reliable and trusted connection to provide secure device communication.

The data port 814 can be any suitable port that enables data communication between the radio 800 and another computing device. The data port 814 can be a serial or a parallel port. In some instances, the data port 814 can be a USB port that includes data lines for data transfer and a supply line that can provide a charging current to charge the battery 830 of the radio 800.

The short-range communications subsystem 822 provides for communication between the radio 800 and different systems or devices, without the use of the wireless network 805. For example, the subsystem 822 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 804 and input to the main processor 802. The main processor 802 will then process the received signal for output to the display 810 or alternatively to the auxiliary I/O subsystem 812. A subscriber may also compose data items, such as e-mail messages, for example, using the keyboard 816 in conjunction with the display 810 and possibly the auxiliary I/O subsystem 812. The auxiliary subsystem 812 may include devices such as: a touch screen, mouse, track ball, infrared fingerprint detector, or a roller wheel with dynamic button pressing capability. The keyboard 816 is preferably an alphanumeric keyboard and/or telephone-type keypad. However, other types of keyboards may also be used. A composed item may be transmitted over the wireless network 805 through the communication subsystem 804.

For voice communications, the overall operation of the radio 800 is substantially similar, except that the received signals are output to the speaker 818, and signals for transmission are generated by the microphone 820. Alternative voice or audio I/O subsystems, such as a voice message recording subsystem, can also be implemented on the radio 800. Although voice or audio signal output is accomplished primarily through the speaker 818, the display 810 can also be used to provide additional information such as the identity of a calling party, duration of a voice call, or other voice call related information.

### CONCLUSION

The terminology used in this application is meant to include all sensors and transmitters and alternate technologies which provide the same functionality as described herein.

1. An apparatus comprising:
a gun holster;
a sensor mounted on the gun holster that is operable to detect a weapon draw; and
a link operably coupled to the sensor that is operable to trigger a panic button condition to a radio of an officer in response to detection of the weapon draw by the sensor, the link being a component of the apparatus.

2. The apparatus of claim 1, wherein the panic button condition further comprises:
notification to dispatch.

3. The apparatus of claim 2, wherein the panic button condition further comprises:
switching the radio of the officer into a hands-free mode.

4. The apparatus of claim 1, wherein the panic button condition further comprises:
switching the radio of the officer into a hands-free mode.

5. The apparatus of claim 1, wherein the panic button condition further comprises:
notification of dispatch; and
switching the radio of the officer into a hands-free mode.

6. An apparatus comprising
a sensor operable to be mounted to a holster and that is operable to detect a weapon draw; and
an transmitter that is operably coupled to the sensor, the transmitter being operable to communicate a message in response to detection of the weapon draw by the sensor.

7. The apparatus of claim 6, wherein the message further comprises:
a panic button condition.

8. The apparatus of claim 7, wherein the panic button condition further comprises:
notification to dispatch.

9. The apparatus of claim 8, wherein the panic button condition further comprises:
switching a radio of an officer into a hands-free mode.

10. The apparatus of claim 7, wherein the panic button condition further comprises:
switching a radio of an officer into a hands-free mode.

11. The apparatus of claim 7, wherein the panic button condition further comprises:
notification to dispatch; and
switching a radio of an officer into a hands-free mode.

12. The apparatus of claim 6, wherein the sensor further comprises
an infrared sensor.

13. The apparatus of claim 6, wherein the sensor further comprises:
a thumb snap on the weapon that is operable to act as a switch/wired circuit break, when the thumb snap of fabric holding the weapon in place is removed, a circuit is changed and detected as the weapon being drawn.

14. The apparatus of claim 6, further comprising:
a gun holster, where the sensor is operable to be mounted on the gun holster.

15. The apparatus of claim 6, further comprising:
a component coupled to at least one of the sensor and the transmitter, operable to prevent false alarms when an officer is off-duty.

16. A method comprising:
detecting a weapon draw; and
communicating a message, in response to detection of the weapon draw.

17. The method of claim 16, wherein communicating the message further comprises:
notifying a dispatch office.

18. The method of claim 17, wherein communicating the message further comprises:
switching a radio of an officer into a hands-free mode.

19. The method of claim 16, wherein communicating the message further comprises
switching a radio of an officer into a hands-free mode.

20. The method of claim 16, wherein communicating the message further comprises:
notifying a dispatch office; and
switching a radio of an officer into a hands-free mode.
